(19) United States
(12) Patent Application Publication
(10) Pub. No.: US 2011/0252479 A1
(43) Pub. Date: Oct. 13, 2011

(54) METHOD FOR ANALYZING RISK

(76) Inventors: Yolanta Beresnevichiene, Bristol (GB); Sandeep N. Bhatt, Madison, NJ (US); William G. Horne, Lawrenceville, NJ (US); Tari Schreider, Duluth, GA (US)

(21) Appl. No.: 12/756,217

(22) Filed: Apr. 8, 2010

(51) Int. Cl. G06F 11/00

(52) U.S. Cl. 726/25

(57) ABSTRACT

A method for analyzing risk to a system, the method being carried out by a computer having a processor and system memory, includes the steps of inputting data representing multiple threat objectives that comprise the risk, calculating a residual risk for each threat objective in view of a plurality of control mechanisms, and generating output representing an overall residual risk to the system that is a combination of the residual risks.

### BACKGROUND

Balancing risk and reward is desirable for organizations of many types. Current economic and business conditions present many organizations with a dilemma of trying to lower costs in order to meet budget reductions, while still providing a high degree of risk management. This dilemma is present in the information technology (IT) field. Maintaining, let alone improving, security controls related to information systems in order to provide a high degree of risk management without additional investment is a difficult task. Many organizations face the dilemma of cutting services without having a pragmatic method to help them understand the impact a reduction may have on their organization's ability to manage risk. Without the ability to quantify the value of security controls, security services are often one of the first areas looked at for cost reductions.

Unfortunately, information technology (IT) managers historically have not been able to quantify the risk associated with reducing security controls, let alone justify the return on investment those security controls offered in the first place. Moreover, when economic conditions improve, organizations can return to investing in IT, and the situation may reverse. That is, IT management may endeavor to find the optimum investment in security controls and resources in order to reduce an organization's risk profile.

### BRIEF DESCRIPTION OF THE DRAWINGS

Various features and advantages of the present disclosure will be apparent from the detailed description which follows, taken in conjunction with the accompanying drawings, which together illustrate, by way of example, features of the present disclosure, and wherein:

FIG. 1 is a flowchart outlining an embodiment of a security and risk analysis method in accordance with the present disclosure;

FIG. 2 is a table setting forth various likelihoods of an attack being initiated;

FIG. 3 is a table setting forth a likelihood that a launched attack will be successful;

FIG. 4 is a table outlining various skill levels for control to be defeated;

FIG. 5 is a table outlining a likelihood of control being defeated based on capability maturity level;

FIG. 6 is a table presenting a template for modeling risks and controls;

FIG. 7 is a table presenting exemplary cost estimates for parts and labor for various security control devices;

FIG. 8 is a table presenting estimated skill levels to defeat each control device presented in FIG. 7;

FIG. 9 is a table presenting a likelihood of a successful attack being launched;

FIG. 10 is a table presenting a likelihood of an attack defeating different choices of controls;

FIG. 11 is a table presenting a joint probability of an attack being successfully launched and defeating different control choices;

FIG. 12 is a table presenting costs of different control choices; and

FIG. 13 is a table presenting the overall residual risk associated with each control combination from FIG. 12 that is within a desired budget.

### DETAILED DESCRIPTION

Reference will now be made to exemplary embodiments illustrated in the drawings, and specific language will be used herein to describe the same. It will nevertheless be understood that no limitation of the scope of the present disclosure is thereby intended. Alterations and further modifications of the features illustrated herein, and additional applications of the principles illustrated herein, which would occur to one skilled in the relevant art and having possession of this disclosure, are to be considered within the scope of this disclosure.

As used herein, directional terms, such as “top,” “bottom,” “front,” “back,” “leading,” “trailing,” etc, are used with reference to the orientation of the figures being described. Because components of various embodiments disclosed herein can be positioned in a number of different orientations, the directional terminology is used for illustrative purposes only, and is not intended to be limiting.

As used herein, the terms “computer” and “microprocessor” refer to any type of computing device, including a personal computer, mainframe computer, portable computer, PDA, smart phone, or workstation computer that includes a processing unit, a system memory, and a system bus that couples the processing unit to the various components of the computer. The processing unit can include one or more processors, each of which may be in the form of any one of various commercially available processors. Generally, each processor receives instructions and data from a read-only memory (ROM) and/or a random access memory (RAM). The system memory typically includes ROM that stores a basic input/output system (BIOS) that contains start-up routines for the computer, and RAM for storing computer program instructions and data.

A computer typically also includes input devices for user interaction (e.g., entering commands or data, receiving or viewing results), such as a keyboard, a pointing device (e.g. a computer mouse), microphone, camera, or any other means of input known to be used with a computing device. The computer can also include output devices such as a monitor or display, projector, printer, audio speakers, or any other device known to be controllable by a computing device. In some embodiments, the computer can also include one or more graphics cards, each of which is capable of driving one or more display outputs that are synchronized to an internal or external clock source.

The term “computer program” is used herein to refer to machine-readable instructions, stored on tangible computer-readable storage media, for causing a computing device including a processor and system memory to perform a series of process steps that transform data and/or produce tangible results, such as a display indication or printed indicia.

The terms “computer-readable media” and “computer-readable storage media” as used herein includes any kind of tangible memory or memory device, whether volatile or non-volatile, such as floppy disks, hard disks, CD-ROMs, flash memory, read-only memory, and random access memory, that is suitable to provide non-volatile or persistent storage for data, data structures and machine-executable instructions. Storage devices suitable for tangibly embodying these instructions and data include all forms of non-volatile memory, including, for example, semiconductor memory devices, such as EPROM, EEPROM, and flash memory devices, magnetic disks such as internal hard disks and removable disks, magneto-optical disks, and optical disks, such as CD, CDROM, DVD-ROM, DVD-RAM, and DVD-RW. Any of the above types of computer-readable media or related devices can be associated with or included as part of a computer, and connected to the system bus by respective interfaces. Other computer-readable storage devices (e.g., magnetic tape drives, flash memory devices, and digital video disks) also may be used with the computer.

One challenge within the field of risk management today is that of finding a uniform method, model or process for organizations to rationalize their security services portfolio at a layer of granularity that facilitates return-on-investment (ROI) projections. That is, return-on-investment in the sense of quantifying what reduction in risk would actually be achieved by investing in certain security tools, controls, and/or services. If executives had an ability to view their security budget in the same manner that private equity firms view their investment portfolios, for example, they may make different security investment decisions.

A typical IT security group has a myriad of security controls and policies that cover such areas as patching, anti-virus, firewalls, intrusion prevention, etc. Making all of these security controls and policies work together to minimize the exposure and susceptibility of an organization's information systems to threats and vulnerabilities is a delicate balancing act. Additionally, it is notoriously difficult to evaluate how well these security tools and processes actually protect an organization, and even harder to estimate in advance the impact a change in security controls and mechanisms or a modification in security policy may have on an organization. It has also been found that security organizations often rely on suspect historical risk data and have few tools to help them understand the trade-offs of investing in different security strategies before placing them into practice.

Some organizations have developed information security management methodologies or models (hereinafter “information security program”, or “InfoSec”) to address some of these challenges. Within an InfoSec, a risk model can be created to expose threats, determine a likelihood of occurrence, and project the likely effects to information and assets. The model can also interact with an InfoSec common control schema, which can serve as an inventory of industry recognized best-practice security controls used to offset threats, subsequently reducing an organization's risk. The InfoSec approach has been used effectively by many large organizations in recent years.

Although the results of the InfoSec approach have been generally favorable, the manual extraction and data manipulation involved in the use of this sort of risk model can impose a cumbersome and unwieldy process that is not easily replicated throughout an organization's InfoSec department or easily applied to risk management projects. Efforts in security analytics research can help systematize an understanding of security policies, risks and investments. This research can provide modeling and simulation approaches and ideas from economics that allow the development of models of security-related business processes and threat environments, and the creation of simulations to predict likely outcomes of policy and technology decisions on security control investments.

There are a variety of approaches for developing risk models that are known by those of skill in the art. Many of these, such as Operationally Critical Threat, Asset, and Vulnerability Evaluation (OCTAVE®), Factor Analysis of Information Risk (FAIR), Facilitated Risk Analysis Process (FRAP), and guidelines from National Institute of Standards and Technology (NIST), have many desirable features. However, these other approaches generally do not provide the ability to optimize a set of security controls.

As disclosed herein, a method has been developed to provide a mathematical and rational basis for an InfoSec risk model, to enable more effective reasoning about risk and the application of mitigating controls. One result of this method is a capability which allows users of InfoSec to determine how to optimize a set of controls to minimize risk, subject to a budget constraint. This approach can help improve the manner in which security and risk management personnel can deliver desired results.

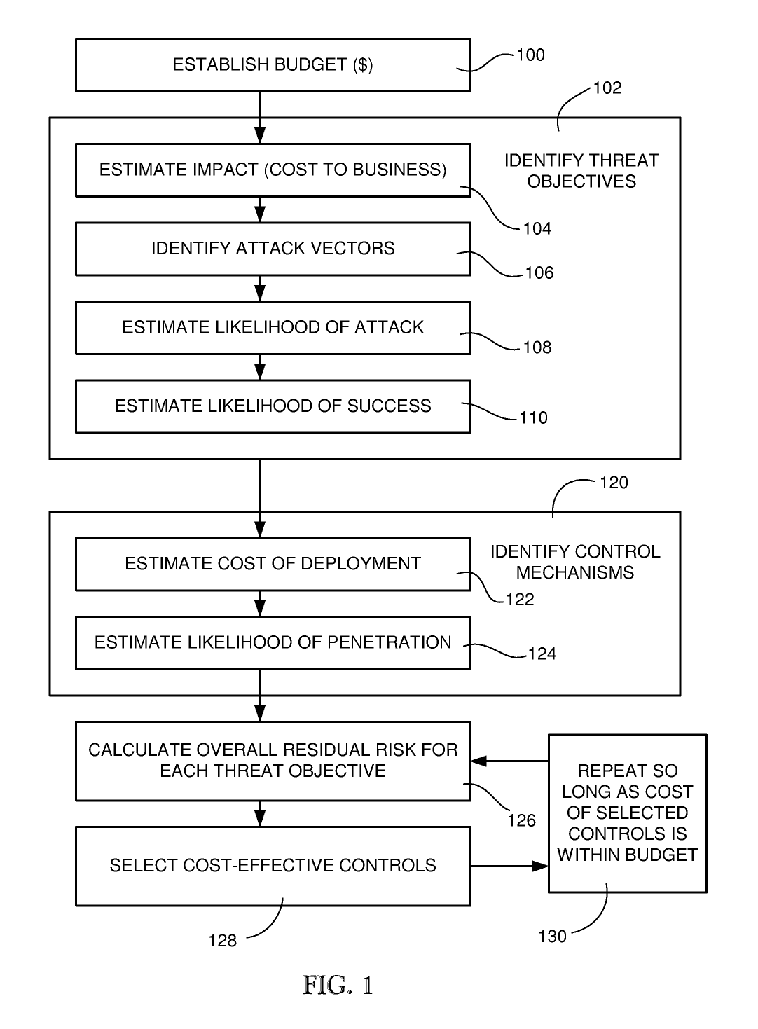

An InfoSec risk assessment is a multi-step approach that guides an organization through the entire lifecycle of risk management. A flowchart outlining the overall process of an embodiment for analyzing risk in accordance with this disclosure is presented in FIG. 1. The process begins by first establishing a monetary budget (step 100) for IT security controls. This budget can be used to govern the ultimate determination of cost-effectiveness for any selected security control. It is to be understood that establishing the budget is presented as a first step as only one example of the method disclosed herein. Those of skill in the art will recognize that the budget can be established at a different point in the process. For example, the budget can be determined after many or most of the other steps in the method have been completed. As another alternative, the budget can be determined after first completing the process entirely for a wide range of control options, allowing IT managers to determine a range of reasonable budget expectations. Other alternatives can also be used.

The process continues next by identifying threat objectives (step 102). The objective is the expected outcome of the threat if it is successful (e.g. “gain access to industrial control system,” or “gain access to Supervisory Control and Data Acquisition (SCADA) system). As shown in FIG. 1, this major step of identifying the threat objectives can be considered to include multiple sub-steps, which involve identifying those threats that could result in a security incident and then determining if those events are likely to occur regularly or rarely and to what degree of certainty. A threat is usually dimensioned by period of occurrence, such as once or twice per year. This can be difficult to calculate because of a lack of credible actuarial data. To overcome this limitation, an InfoSec system can provide a systematic approach to let domain experts evaluate these likelihoods qualitatively, and convert these into probability estimates for use in the analysis.

When performing a risk assessment it is desirable to first properly assess the threats that are specific to an organization, its business processes, location, and other characteristics. Some of these threats are generic, i.e. they could impact an organization regardless of the nature of its business. There are a number of references known to those of skill in the art that are used for recognized threat categories, such as NIST reports, OCTAVE® and Microsoft's® STRIDE®, as well as other threat environment reports. Based on these or other references, and inventory of pre-defined threats and compliance events can be created.

Identified threats are inventoried and articulated into risks by taking into account an organization's business and technology impacts. One aspect of this analysis is to estimate the monetary impact that a particular threat poses to the business. (step 104) That is, if a particular threat were successful, what would be the likely monetary damage to the business? Other relevant factors are also identified, including anticipated attack vectors (step 106). An attack vector is the path or technology that is used to perpetrate the attack (e.g. “dial-tone POTS line”).

The next sub-step as part of identifying threat objectives (step 102) is to estimate the likelihood that a particular threat will be manifested. In general, the likelihood of a particular threat can be considered as being primarily due to two factors: the likelihood that the attack will be initiated (estimated at step 108) and the likelihood that, if initiated, the attack will be successful. (estimated at step 110) These likelihoods can be derived by considering a wide variety of factors such as the type of skill a person would need to carry out an attack, how that attack would be initiated as well as how complex the attack is to mount.

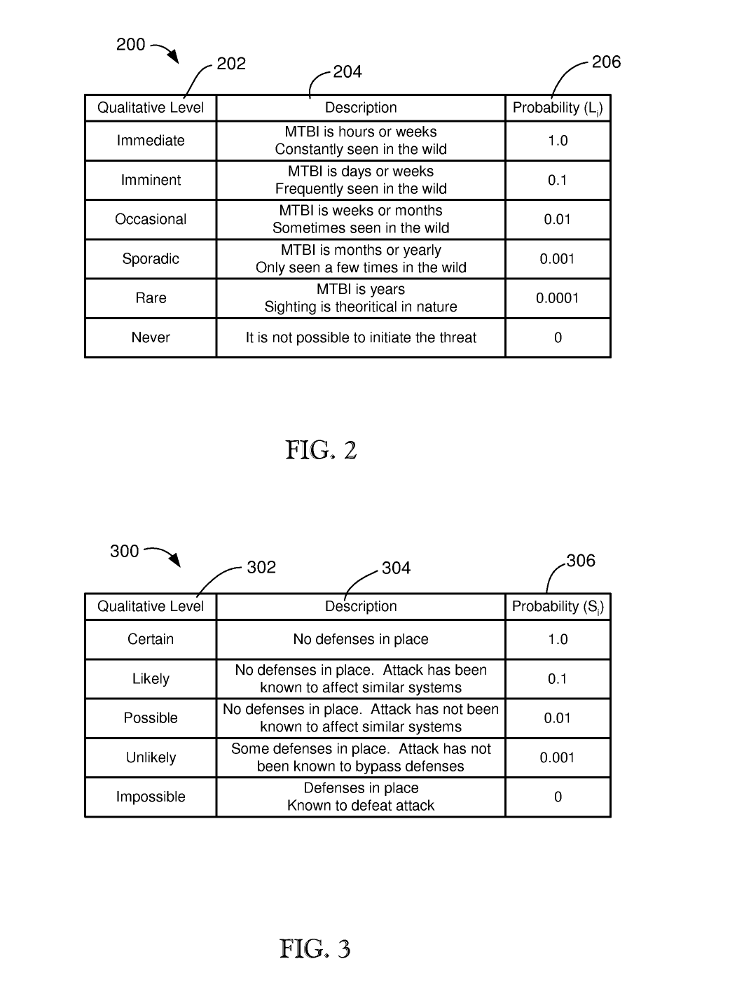

Presented in FIGS. 2 and 3 are tables setting forth various likelihoods of an attack being initiated (FIG. 2), and a likelihood that a launched attack will be successful (FIG. 3). In the table 200 of FIG. 2, the “Qualitative Level” or temporal frequency of an attack is shown in column 202, a description of the temporal frequency is provided in column 204, and the probability of the attack is shown in column 206. In this table the term MTBI represents Mean Time Between Incidents, and the accompanying description gives an example of the type of probability involved. Probabilities that differ by orders of magnitude are assigned to each of these likelihood categories. It is to be understood that probability assignment by orders of magnitude, as presented herein, is only one example. Other probability assignments can also be used. The table 300 in FIG. 3 presents the qualitative description of a likelihood that a launched attack will be successful in column 302, a description of the defenses and their known characteristics in column 304, and the probability (by orders of magnitude) that the attack will be successful in column 306. These two tables are exemplary of the type of analysis that can be used to give domain experts guidance on choosing a particular level of likelihood for each of these categories. As noted above, part of the overall step of identifying threat objectives, probabilities that differ by orders of magnitude are assigned to each likelihood category. This analysis allows organizations to prioritize threats by order of most likely to occur and by impact potential.

In general the result of a risk assessment is a library or register of threats, with each threat having been characterized with properties such as name, source, objective, instrument, vector, target, complexity, exposure, result, loss expectancy, likelihood of occurrence, and impact. The name is the designation for the event that poses a threat (e.g. “compromised dial-up modem”). The source designation provides insight to origin-based mitigation/management strategies (e.g. “hacker”). The objective is the expected outcome of the threat if it is successful (e.g. “gain access to industrial control system,” or “gain access to SCADA system”). The instrument is the technology or process that is likely to be used to enable the threat to occur (e.g. “telephone war dialer”). The vector is the path or technology used to perpetrate the attack (e.g. “dial-tone POTS line”). The target is the ultimate target the threat would affect (e.g. “modems for OEM remote support access, out of band ICS access, maintenance to protect relay substations, or non-managed assets connected to the ICS”).

Complexity is determined based on the objective, instrument, vector and target, and can be specified as a value from 0 to 1. Exposure refers to exposure to the asset or organization if the threat were to occur (e.g. “unauthorized access to either a critical or non-critical asset”). The result is the ultimate effect if the threat is realized (e.g. “compromised network access point”). Loss expectancy is the annual loss expectancy (ALE) (e.g. estimated as a dollar value) based on exposure and threat result, together with a business impact assessment (BIA). Likelihood of occurrence is the probability that a particular threat might materialize. This can be expressed as a number between 0 and 1. The NIST framework can be used to describe the bands (high, medium, or low) in which the threat likelihood can be matched to a BIA study or general consensus. The impact can be defined as a value between 0 and 100; again, a NIST framework can be used to identify the bands in which the threat impact can be categorized.

Once threats are identified by likelihood and impact (step 102 in FIG. 1), the next stage of analysis is to identify the controls best suited to manage and/or mitigate the estimated risk wrought by the threats through a process of risk modeling. This general step is indicated at 120 in FIG. 1. In an InfoSec control assessment and schema, controls are selected based on their ability to address a given threat. Existing controls can be identified through workshops, interviews, and surveys, and then can be detailed in maps, workflows and diagrams in forms such as: templates to ensure that controls conform to a uniform structure; an abstract layer to form a blueprint of how security services are deployed; attack surface protection strategies (e.g. security tools) to actuate an InfoSec program; and visualization of component-level interaction.

Analysis of additional properties can also be used to identify control effectiveness. These properties can include people (personnel that are assigned to oversee and manage controls), policies/procedures (governance artifacts that are used to specify a control's purpose and operation), processes (operational sequences of activities or events that are designed to reduce risk), products (technologies or solutions that are used to manage or mitigate risk) and proof (metrics or validation methods used to track the effectiveness of control mechanisms).

As part of this control analysis, the cost of deployment of different controls are estimated. (step 122) An exemplary table 700 of control device costs is provided in FIG. 7, and is discussed in more detail below. Next, the ability for adversaries to defeat a particular control is considered, as a base level. This is referred to as a likelihood of penetration: that is, the likelihood that a particular attack will penetrate a given control. (step 124) Again, qualitative levels are used to describe skill level and tools available to defeat the control and assign probabilities to these levels according to an order of magnitude scale.

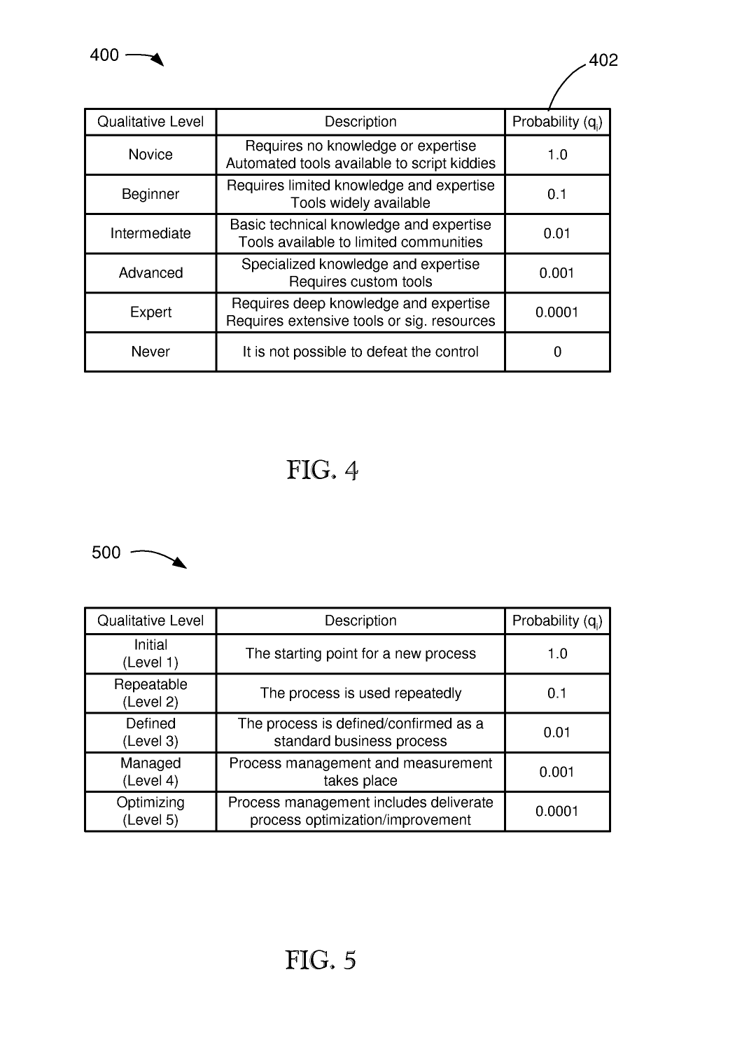

Estimating the likelihood of penetration (step 124) can involve multiple sub-steps. The effectiveness of existing or proposed controls to address threats can be determined by examining the sophistication of the skills required by an adversary to defeat the control, and the ability of the organization to effectively deploy the control. Since some controls may require substantially more skill than others in order to defeat, guidance for domain experts to choose a skill level is given, such as shown in the table 400 of FIG. 4, which outlines various skill levels for control to be defeated. The more complete a control's properties are, the more mature a control is considered.

The InfoSec can also integrate a method or model for determining control maturity, which is also considered in the determination of likelihood of penetration analysis. This control maturity model can be applied through performing interviews and examining supporting documentation for each property of a control. These properties can include people (personnel that are assigned to oversee and manage controls), policy/procedures (governance artifacts that are used to specify a control's purpose and operation), processes (operational sequences of activities or events that are designed to reduce risk), products (technologies or solutions that are used to manage or mitigate risk) and proof (metrics or validation methods used to track the effectiveness of control mechanisms). It is desirable to establish the maturity of a control in order to determine its beneficial impact on an organization. Improving the maturity of a control improves the control's effectiveness. Again, quantitative levels are used to describe control maturity, to which probabilities are then assigned that differ by orders of magnitude. Provided in FIG. 5 is a table 500 outlining a likelihood of control being defeated based on various capability maturity levels.

Any gaps in security can also be identified where there are no controls to mitigate certain risks, or where existing controls are weak. Based on best security practices and established standards, a new set of controls might then be recommended to cover the risk gaps. For example, once gaps in a current risk treatment are identified, the InfoSec can be used to produce remediation control templates that are compiled based on various control design attributes relating to industry standards and best practices. Controls can be deployed based on the level of control maturity required to accommodate an organization's budget and appetite for risk.

In view of the above risk analysis methodology, a formal mathematical method has been developed to support and ground the dependencies and relationships behind the information gathered by the ISM. Referring to FIG. 1, this method generally involves calculating an overall residual risk for each threat objective (step 126) and selecting a cost-effective control for that threat. (step 128) These two steps can be repeated (step 130) so long as the cost of the selected control does not exceed the budget established in step 100.

As noted above, each threat in the formal model represents a potential target objective of an attacker, and each objective is associated with an impact. The impact is denoted v and can be measured in dollars (or other monetary units). As noted above, the impact represents the damage that would be caused if the objective were compromised. Multiple threat vectors can be associated with each objective, each vector corresponding to a different path an attacker can exploit to compromise the target.

Each threat vector is associated with a likelihood, denoted ρᵢ, that the attack will be launched and succeed, assuming no controls are in place. This likelihood can be obtained as the product of the probability that the attack will be launched, times the probability that the attack will penetrate the system to reach the target if no controls are deployed. While these two quantities are difficult to measure, or even define precisely, estimates determined using the qualitative techniques described above can be used.

The product of the likelihood times the estimated impact is called the risk, and represents the expected loss associated with the threat vector. The total overall likelihood from all threat vectors is then calculated using the inclusion-exclusion principle, and the overall residual risk is the product of the overall likelihood times the impact of the threat objective.

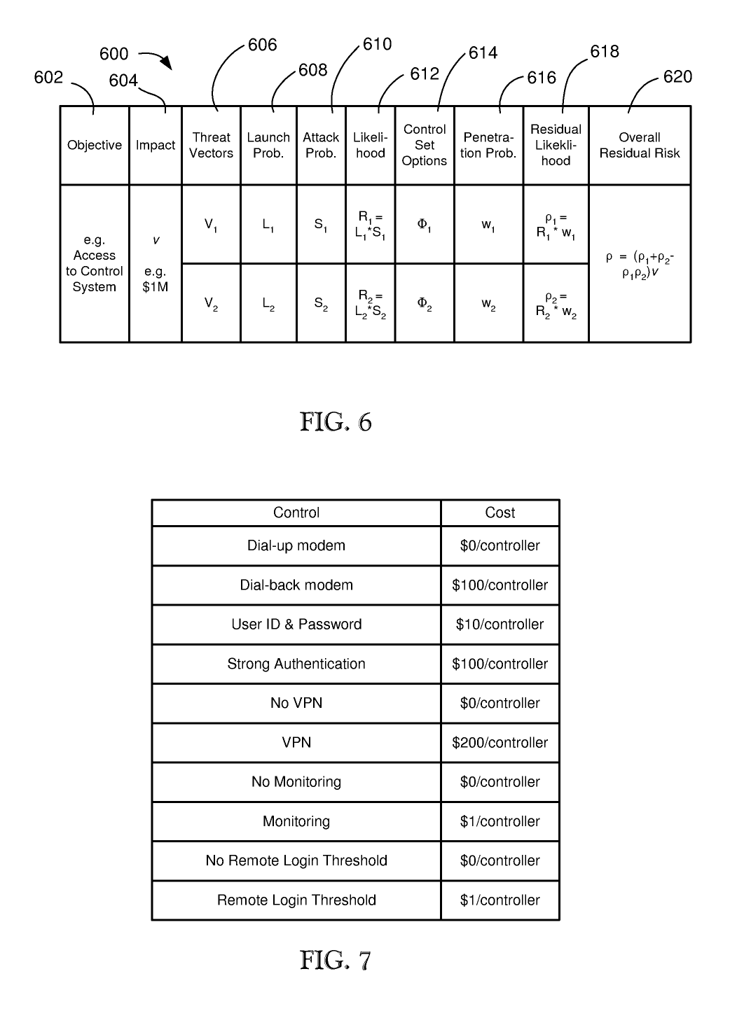

Provided in FIG. 6 is a table 600 presenting a template for modeling risks and controls for use in the mathematical model. The first column 602 of this table identifies an attack objective. Each objective is associated with an impact, denoted v, presented in column 604. Multiple threat vectors, denoted Vₙ and shown in column 606, can be associated with each objective. The table in FIG. 6 is divided into two rows corresponding to two particular attack vectors, V₁ and V₂. It is to be understood that this is exemplary only. Any number of threat vectors can be associated with a given attack objective.

Each threat vector is associated with a likelihood, denoted Rᵢ and shown in column 612, that the attack will be launched. This likelihood can be obtained as the product of the probability Lᵢ that the attack will be launched (column 608), times the probability Sᵢ that the attack will succeed (column 610), as given by the following equation:

Rᵢ=Lᵢ*Sᵢ [1]

An example of this computation is provided in FIG. 9, and discussed in more detail below. As discussed above, FIGS. 2 and 3 present exemplary attack and success probabilities for use in this calculation. For example, the table 200 in FIG. 2 shows in column 206 various probabilities Lᵢ that an attack will be launched. Table 300 shows in column 306 various probabilities Sᵢ that an attack will be successful. These quantities are only exemplary, but show the type of information that is used to determine the likelihood Rᵢ.

Next, it is desirable to consider the options that a defender has: namely, the choice of controls that will help thwart attacks along different vectors, thereby reducing the overall risk. A defender has a choice of different kinds of controls to thwart an attack. Access control, intrusion detection, and authentication are all different types of controls that can be used as part of a comprehensive strategy to thwart or minimize the impact of an attack. In table 600 the control set options are designated φᵢ (column 614). Each type of control can be implemented with different choices of mechanisms—different mechanisms incur different costs, and also differ in their ability to thwart different attacks. In general, the defender has a choice of selecting some control types as part of strategy and, for each control type, selecting one control mechanism. For example, if A and B are two control types containing, respectively, mechanisms a₁ . . . aₘ and b₁ . . . bₙ, the defender has (m+1) (n+1) choices; he may select either zero or one control mechanism of either control type.

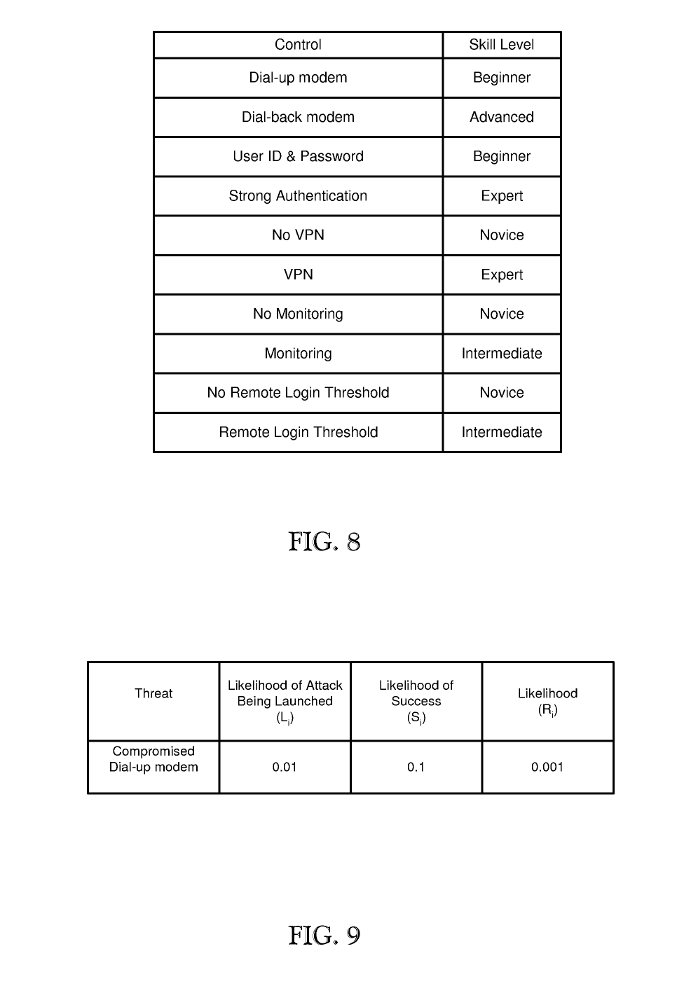

Each control mechanism has a known cost of deployment, which may, for example, include the fixed and marginal costs of deploying the control over a specified period of time. A table presenting cost of deployment of various control mechanisms is provided in FIG. 7. A skill level for penetration of each control mechanism can also be assigned, as presented in FIG. 8. These skill levels relate back to table 400 in FIG. 4, which shows in column 402 various probabilities qᵢ of penetrating a given control mechanism based on the skill level of the attacker. Each control mechanism can be assigned a probability qᵢ of thwarting an attack vector, and this probability can be different for different vectors. As before, these probabilities can be estimated by InfoSec consultants in concert with operations staff and are estimates that depend on several factors, including the ability for the organization to deploy the control effectively.

An additional factor that can enter into the penetration probability computation is the capability maturity level of a given control mechanism. An example of probabilities qᵢ based upon capability maturity level is given in table 500 in FIG. 5. The probability of penetration of a given control can be the product of the skill level penetration probability of FIG. 4 times the capability maturity level penetration probability of FIG. 5.

To achieve an attack objective, the attacker must penetrate each choice of control type. A simplifying assumption can be made that the ability to penetrate one control is independent of the ability to penetrate another control, which is how an organization achieves a defense-in-depth architecture. For any attack vector, the overall ability wᵢ (column 616) of the hacker to penetrate the set of selected controls is the product of all probabilities qᵢ, given by the equation:

wᵢ=Π*qᵢ [2]

where qᵢ represents the probability of penetrating the ith deployed control mechanism. The residual likelihood against this threat vector is then given by

ρᵢ=Rᵢ*wᵢ. [3]

This quantity is given in column 618 in FIG. 6. As noted above, the total overall likelihood associated with a threat objective is then calculated using the inclusion-exclusion principle across all threat vectors for that objective. For the example shown in FIG. 6, with two threat vectors, the overall likelihood is:

(ρ₁+ρ₂−ρ₁ρ₂) [4]

This quantity is not shown in its own column in FIG. 6, but is included in the quantity of column 620. The inclusion-exclusion principle is well known to those of skill in the field of combinatorial mathematics, and it can be applied to situations with any number of threat vectors. The overall residual risk ρ for a given threat across all threat vectors is equal to the impact v times this overall likelihood. In the example of FIG. 6, the overall residual risk (which will be expressed in monetary units, e.g. dollars) becomes:

ρ=v(ρ₁+ρ₂−ρ₁ρ₂) [5]

This quantity is shown in column 620 in FIG. 6. In the example of FIG. 6, one threat objective (column 602) with two threat vectors (column 604) is shown. It is to be understood that where there are multiple threat objectives, the total risk associated with an entire system will be the sum of the overall residual risks (column 620) over all threat objectives.

Several simplifying assumptions in both the risk model and the control portfolio optimization framework have been made, which are detailed here. First, it can be assumed that various probabilities are available: the probability that an attack is successful, the probability that a control can mitigate an attack, etc. As noted earlier, it is difficult to define these probabilities precisely or to estimate them with a high-degree of accuracy.

However, a lack of accuracy in estimating these probabilities does not render the solution invalid. In practice, instead of using numerical values for such probabilities, these kinds of probabilities can be converted into discrete ranges, such as “low”, “medium”, and “high.” Those skilled in the art can assign values in these types of ranges if they are given guidance on what those ranges mean. These probabilities can be decomposed into components that InfoSec practitioners can assess with some course quantification. Second, various types of independence can be assumed. For example, it can be assumed that the ability to defeat various kinds of controls is independent. It can also be assumed that the individual threats are independent, which allows the risk values to be carried through. In reality, skilled hackers possess several tools to defeat a variety of controls, and it may be difficult to separate threats into categories that are independent. In principle, this problem can be overcome with more sophisticated models that account for dependent variables.

Assigning rough numerical values and a formal framework is believed to capture expert reasoning and find solutions that are judged reasonable. In short, the value of the analysis is to be found not in the calculations, but in the quality of the answers. A set of examples can justify this vision.

The method disclosed herein also provides an approach to optimize a portfolio of security controls. Security decisions often involve trade-offs: a security policy choice that optimizes time spent by the security team might create burdens (cost) for IT operations or the business; and a decision to spend money defending one risk can mean reduced resources for combating other threats. It is desirable that the resources available in a fixed security budget be allocated in proportion to the security priorities a particular organization has and in response to the impact from potential threats.

Choosing which security controls to invest in with the goal of minimizing residual risk is not a trivial task. Budget constraints generally prohibit selecting all controls. Also some controls may not be practically possible, as they might be dependent on technical constraints or staff competencies that might be missing in a particular organization. On the other hand, legal and compliance constraints may place priorities on one set of controls rather than another.

During customer engagements, the InfoSec approach produces a lot of threat and control data that is stored across disparate spreadsheets. In order to identify the controls that should be implemented to reduce the risk, a manual data analysis process is used, often relying on the consultant's expertise to choose the appropriate defense mechanisms. By using the mathematical framework described previously and by applying an economic utility maximization approach together with search algorithms a solution can be developed that allows the stakeholders (e.g. the consultants and the customer) to more easily explore control investment choices, and ultimately choose the optimal solution. Following is a description of an approach to control selection optimization, including the utility function that can be used and a set of search optimization algorithms that have been used.

In exploring this issue, the optimization challenge is to determine an optimal set of controls φ that results in the greatest reduction in risk, but whose total cost is no more than some specified budget B or reasonable in light of the potential impact cased by the threat. This is a combinatorial optimization problem. It involves searching through an exponential set of combinations of controls to find the correct solution. Although the problem in its full generality is NP-Complete, it is believed that sub-optimal algorithms are likely to provide solutions that are within an acceptable range. Several algorithms can be used to find such solutions. For example, a greedy algorithm could be used in which, at each step, the control that leads to the greatest reduction in risk, but still stays within the available budget, is selected.

Following is an illustrative example that helps to show how the method disclosed herein is implemented. For this example, it is assumed that the XYZ energy company has one thousand remote terminal units (RTU) controlled by a SCADA system to control the flow of oil through pipelines. These RTUs are located in remote locations, so dispatching a service unit to the controller is expensive (on average $100 per box). As a result, XYZ has installed modems in the boxes so that they can reach them remotely when doing basic maintenance, view statistics of their usage, etc. However, they are looking to improve the security of these boxes to meet and exceed North American Electric Reliability Corporation (NERC) Critical Infrastructure Protection (CIP) compliance requirements. XYZ has a budget of $200,000 to improve the security of their RTUs.

The primary threat is that an adversary can dial into either the SCADA system and/or RTUs and perform some malicious act of sabotage. An obvious control would be to disconnect the phone line, and have any service be done locally, but this is deemed to be too expensive and impractical. XYZ's domain experts determine that the likelihood of an attack being initiated is occasional (as per FIG. 2), and the likelihood that the attack is successful is likely (as per FIG. 3), since they currently have no controls in place, and there are reports of such attacks happening in the past year. Using the corresponding values from FIGS. 2 and 3, the likelihood of an attack that results in a compromised dial-up modem is 0.001, as shown in FIG. 9.

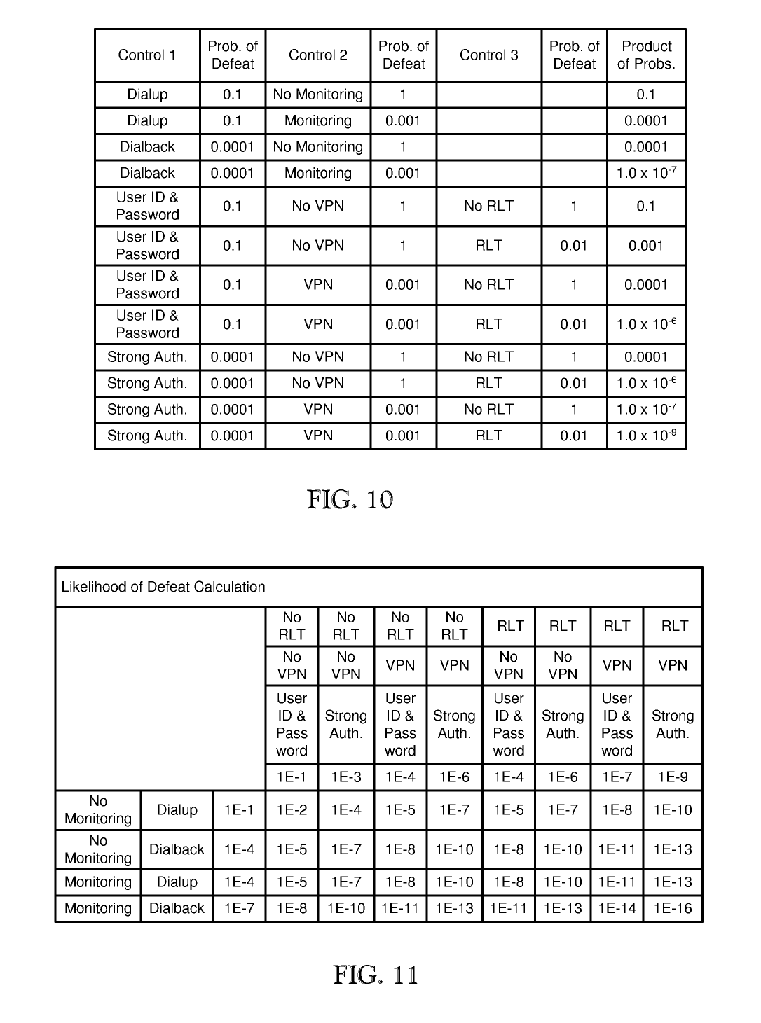

XYZ is considering several controls: dial back modems, user id & password authentication, strong authentication, a VPN (virtual private network) into the controller, logging and monitoring connections to the controllers, and locking out the boxes if a threshold number of unsuccessful authentication attempts occurs (Remote Login Threshold or RLT). The cost estimates shown in FIG. 7 give costs for parts and labor to install each of the controls. The respective skill levels to defeat each control are shown in FIG. 8. For the purposes of this example, it can be assumed that these controls can all be applied at the maximum capability (maturity) level. A table setting out a probability of defeat for each control, and a product of the probabilities for all combinations of the above control options, is given in FIG. 10.

FIG. 11 provides a table presenting a joint probability of attack being successfully launched and defeating different control choices. That is, the values in FIG. 11 are the product of the probabilities calculated in FIG. 10, times the attack likelihood presented in FIG. 9. This is the residual likelihood, like that represented in column 618 of FIG. 6. For brevity, these probabilities are expressed in exponential notation—for example, the FIG. 1E-10 representing 1.0×10⁻¹⁰.

The next step is to consider the cost of the control options. A table showing the costs for all control alternatives shown in FIGS. 7 and 8 is presented in FIG. 12. From this figure, it can be seen that many of the options are within the $200,000 budget, while some are not.

Following the analysis methodology described above, each cost in FIG. 12 is multiplied by the corresponding likelihood of defeat number from FIG. 11. That is, the probabilities from FIG. 11 are each multiplied by the control cost for the respective option, times a thousand (the number of SCADA controls that XYZ has). This is the step of calculating the overall residual risk, where the probability of penetration is multiplied by the impact or cost. It will be noted that in this example the impact is the cost of the controls, for use in comparison to the budget, rather than an estimate of the likely damages from a successful attack.

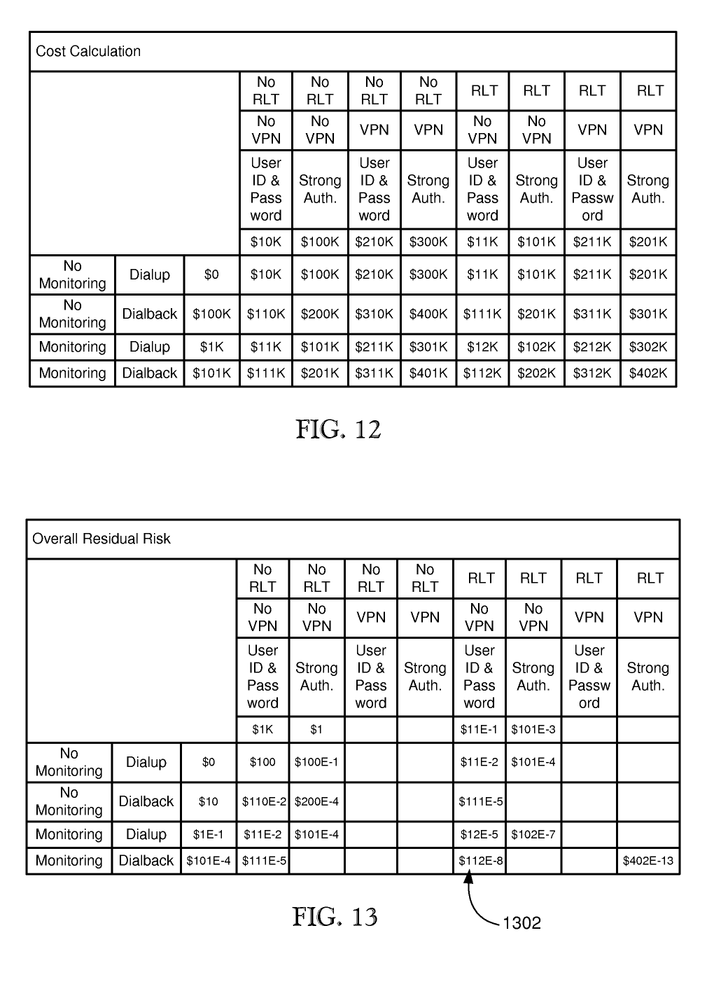

FIG. 13 provides a table showing the results of this calculation. When the overall residual risk is calculated for each of the control options from FIG. 12 that are within budget, the optimal solution is the one with the lowest overall residual risk: that is, the lowest number in FIG. 13, indicated at 1302. From this table it can be seen that the optimal solution in this example utilizes dial-back modems, a user ID and password scheme, monitoring of the connections, and remote login thresholds. The likelihood of defeat value for this option is 1.0×10⁻¹¹, shown in FIG. 11, and the associated cost is $112,000, shown in FIG. 12. From these figures, it can be seen that while this solution is not the least expensive, it provides the lowest overall residual risk of the options from FIG. 12 that are within budget.

Even for a simple example like this, the number of combinations is quite large. For simplicity, this analysis has not specifically considered some of the factors that can make the problem even more complex, including multiple threats, multiple vectors of attack, and the capability of the organization to deploy the controls. However, the method disclosed herein can be used to consider these additional issues. In particular, in performing the method disclosed herein, each of the values discussed herein, such as those associated with impact, threat vectors, launch and attack probability, control options and costs, penetration probabilities, and so on, can be input into a computer system having a processor and system memory, and having program code stored in tangible computer-readable storage memory, for causing the computer system to calculate likelihoods of attack and success, and to determine a risk associated with various threat vectors, and then calculate a residual risk across multiple threat vectors. Following this method, IT managers can quantify the risk associated with reducing security controls, as well as justify the return on investment those security controls offer. Moreover, IT management can use this method to find an optimum investment in security controls and resources in order to reduce an organization's risk profile.

It is to be understood that the above-referenced arrangements are illustrative of the application of the principles disclosed herein. It will be apparent to those of ordinary skill in the art that numerous modifications can be made without departing from the principles and concepts of this disclosure, as set forth in the claims.

What is claimed is:

1. A method for analyzing risk to a system, the method being carried out by a computer having a processor and system memory, comprising the steps of:
a) inputting into the computer data representing multiple threat objectives that comprise the risk;
b) the computer calculating a residual risk for each threat objective in view of a plurality of control mechanisms; and
c) the computer generating output representing an overall residual risk to the system that is a combination of the residual risks.

2. A method in accordance with claim 1, wherein the residual risk associated with a particular threat objective is equal to a likelihood of success of the attack against the threat objective, times an expected monetary impact if the attack is successful.

3. A method in accordance with claim 2, further comprising the steps of:
d) the computer estimating a modified likelihood of success and/or modified impact, from implementation of a selected control mechanism; and
e) the computer calculating the residual risk as the modified likelihood of success of the attack times the modified impact.

4. A method in accordance with claim 2, wherein the residual risk values are equal to a combined likelihood of attack and success of the attack, multiplied by a penetration probability of the attack against a selected control mechanism.

5. A method in accordance with claim 4, wherein the penetration probability is equal to the product of all probabilities of penetrating each given control mechanism.

6. A method in accordance with claim 5, wherein the residual risk associated with a particular threat objective is calculated using the inclusion-exclusion principle applied to multiple residual risk values, each residual risk value being associated with a different threat objective.

7. A method for optimizing IT security controls, the method being carried out by a computer having a processor and a system memory, comprising the steps of:
a) inputting into the computer data representing an IT security control budget and multiple security control mechanisms that can each individually be within the budget;
b) inputting into the computer data representing multiple threat objectives that comprise risk to an IT system;
c) the computer calculating a residual risk for each threat objective in view of the control mechanisms; and
d) the computer transforming the data and generating output representing a combination of control mechanisms having a lowest overall residual risk and a total cost that is within the budget.

8. A method in accordance with claim 7, wherein the residual risk associated with a particular threat objective is calculated using the inclusion-exclusion principle applied to multiple residual risk values, each residual risk value being associated with a different threat objective.

9. A method in accordance with claim 7, wherein the residual risk associated with a particular threat objective is equal to a likelihood of success of the attack against the threat objective, times an expected monetary impact if the attack is successful, each of the likelihood and impact being modified with respect to a given control mechanism.

10. A method in accordance with claim 7, wherein the residual risk associated with a particular threat objective is equal to a likelihood of success of the attack against the threat objective, times an expected monetary impact if the attack is successful, times a penetration probability of the attack.

11. A method in accordance with claim 10, wherein the penetration probability is equal to the product of all probabilities of penetrating each given control mechanism.

12. A computer program product, comprising machine-readable instructions, stored on tangible computer-readable storage media, for causing a computing device including a processor and system memory to perform the steps of:
a) identifying multiple threat objectives of an IT system, and multiple control mechanisms, each control mechanism having a cost;
b) calculating a residual risk for each threat objective in view of each control mechanism; and
c) generating output representing an overall residual risk to the system that is a combination of the residual risks.

13. A computer program product in accordance with claim 12, further comprising instructions for causing the computer to perform the steps of:
d) repeating steps (a) and (b) for different combinations of control mechanisms so long as the cost remains within a budget; and
e) providing output indicating a combination of control mechanisms having a lowest overall residual risk and a total cost that is within the budget.

14. A computer program product in accordance with claim 12, further comprising instructions for calculating the residual risk using the inclusion-exclusion principle applied to multiple residual risk values, each residual risk value being associated with a different threat objective.

15. A computer program product in accordance with claim 12, wherein the residual risk associated with a particular threat objective is equal to a likelihood of success of the attack against the threat objective, times an expected monetary impact if the attack is successful, times a penetration probability of the attack.
